(19) United States
(12) Patent Application Publication
(10) Pub. No.: US 2015/0050552 A1
(43) Pub. Date: Feb. 19, 2015

(54) LITHIUM ION SECONDARY BATTERY AND METHOD FOR MANUFACTURING SAME

(71) Applicants: Akihiro Matsuyama, Susono-shi (JP); Seishu Komune, Fukuoka-ken (JP)

(72) Inventors: Akihiro Matsuyama, Susono-shi (JP); Seishu Komune, Fukuoka-ken (JP)

(21) Appl. No.: 14/358,129

(22) PCT Filed: Jul. 13, 2012
(86) PCT No.: PCT/JP2012/067985

§ 371 Date: Aug. 12, 2014

(30) Foreign Application Priority Data
Nov. 16, 2011 (JP) 2011-250369

(51) Int. Cl. H01M 4/36; H01M 10/058; H01M 10/0525; H01M 4/04; H01M 10/0568; H01M 4/50

(52) U.S. Cl. CPC H01M 4/366; H01M 10/0568; H01M 4/50; H01M 10/0525; H01M 4/0404; H01M 10/058; H01M 2300/0025; H01M 2220/20
USPC 429/199; 429/221; 29/623.5

(57) ABSTRACT

Provided is a lithium ion secondary battery demonstrating improved manganese dissolution inhibition performance when the lithium ion secondary battery is charged and discharged. In the lithium ion secondary battery, a positive electrode (64) includes a positive electrode collector (62) and a positive electrode active material layer (66) including at least a positive electrode active material (70) and formed on the positive electrode collector. The positive electrode active material (70) is mainly constituted by a manganese-containing lithium complex oxide (72) including lithium and at least manganese as a transition metal element and includes a coating film (74) of an amorphous structure including at least iron (Fe) and fluorine (F) formed on at least part of a surface of the manganese-containing lithium complex oxide.

### TECHNICAL FIELD

The present invention relates to a lithium ion secondary battery and a method for manufacturing same. More specifically, the present invention relates to a lithium ion secondary battery provided with a positive electrode active material including a manganese-containing lithium complex oxide as a main component, and to a method for manufacturing same.

The present application claims priority to Japanese Patent Application No. 2011-250369 filed on Nov. 16, 2011, the entire contents of which is incorporated herein by reference,

### BACKGROUND ART

A lithium ion secondary battery includes a positive electrode, a negative electrode, and an electrolytic solution (nonaqueous electrolytic solution) interposed between those two electrodes, the battery is charged and discharged by transfer of lithium ions between the positive electrode and negative electrode through the electrolytic solution including a support electrolyte such as a lithium salt. The positive electrode includes a positive electrode active material that reversibly stores and releases lithium ions. Examples of such positive electrode active materials include lithium complex oxides (lithium-containing compounds) including lithium and at least one transition metal element. A manganese-containing lithium complex oxide including at least manganese (Mn) as the transmission metal element is a positive electrode active material that has a high capacity and excels in thermal stability. Patent Literature 1 is an example of prior art literature relating to a lithium ion secondary battery including such positive electrode active material. Patent Literature 1 describes a lithium ion secondary battery provided with a lithium manganese oxide, which is a manganese-containing solid solution.

### CITATION LIST

### Patent Literature

Patent Literature 1: Japanese Patent Application Publication No. 2010-282874

Patent Literature 2: Japanese Patent Application Publication No. H10-144291

### SUMMARY OF INVENTION

### Technical Problem

However, with the technique described in Patent Literature 1, when the lithium ion secondary battery constructed using a manganese-containing lithium complex oxide as a positive electrode active material is charged and discharged, manganese contained in the positive electrode active material can be eluted into the electrolytic solution and battery performance cart be degraded.

The present invention has been created to solve the above-described problem inherent to the related art, and an objective of the present invention is to provide a lithium ion secondary battery demonstrating improved manganese dissolution inhibition performance when the lithium ion secondary battery is charged and discharged, and also to provide a method for advantageously manufacturing such secondary battery.

### Solution to Problem

In order to attain the abovementioned objective, a lithium ion secondary battery comprising a positive electrode, a negative electrode, and a nonaqueous electrolytic solution is provided. In the lithium ion secondary battery disclosed herein, the positive electrode is provided with a positive electrode collector and a positive electrode active material layer including at least a positive electrode active material and formed on the positive electrode collector. The positive electrode active material is a film-coated positive, electrode active material that is mainly constituted by a manganese-containing lithium complex oxide including lithium and at least manganese as a transition metal element and includes a coating film of an amorphous structure formed on at least part of a surface of the manganese-containing lithium complex oxide and includes at least iron (Fe) and fluorine (F).

The lithium ion secondary battery provided by the present invention includes the positive electrode active material in which a coating film of an amorphous structure including at least iron (Fe) and fluorine (F) is formed on at least part of a surface of the manganese-containing lithium complex oxide.

Where at least part (preferably, substantially the entire surface) of the surface of the manganese-containing lithium complex oxide capable of reversibly storing and releasing lithium ions is thus covered by a coating film of an amorphous structure including at least iron (Fe) and fluorine (F), which is a substance other than the oxide, the manganese contained in the manganese-containing lithium complex oxide is prevented from being eluted from the oxide into the nonaqueous electrolytic solution when the lithium ion secondary battery is charged and discharged. As a result of such inhibition of manganese elution, the structure of the manganese-containing lithium complex oxide is stably maintained. Therefore, with the film-coated positive electrode active material provided with the film, the space where lithium ions can be stored and released is also maintained and the decrease in a capacity retention ratio can be prevented.

Patent Literature 2 discloses the technique of forming an amorphous layer on the surface of a metal compound (positive electrode active material), but this amorphous layer is obtained by amorphization of part of the surface of the positive electrode active material itself by ion implantation and has a configuration different from that of the above-described invention of the present application.

In a preferred embodiment of the lithium ion secondary battery disclosed herein, a molar ratio (F/Fe) of fluorine (F) to iron (Fe) included in the coating film with the amorphous structure is greater than 1 and less than 6 (preferably equal to or greater than 2 and equal to or less than 5, more preferably equal to or greater than 3 and equal to or less than 4).

With such a feature, the coating film of the preferred form is formed on the surface of the manganese-containing lithium complex oxide. Therefore, a lithium ion secondary battery with excellent performance (excellent capacity retention ratio) can be obtained.

In another preferred embodiment of the lithium ion secondary battery disclosed herein, the amount of the coating film is 0.5% by mass to 1.5% by mass, where the entire film-coated positive electrode active material is taken as 100% by mass.

With such a feature, the coating film of an adequate amount is formed on the surface of the manganese-containing lithium complex oxide. Therefore, a lithium ion secondary battery with excellent performance can be obtained.

In another preferred embodiment of the lithium ion secondary battery disclosed herein, the manganese-containing lithium complex oxide includes a layered rock salt structure or a spinel structure. It is preferred that the manganese-containing lithium complex oxide include a redox potential equal to or higher than 4.6 with respect to a metallic lithium electrode.

By using the manganese-containing lithium complex oxide with such a high potential, it is possible to obtain a high battery voltage when the lithium ion secondary battery is fully charged, but manganese can be eluted from the oxide as a result of the reaction proceeding on the interface (surface) of the nonaqueous electrolytic solution and the oxide under such a high voltage. Therefore, the effect demonstrated by using the configuration in accordance with the present invention, that is, the configuration provided with a film-coated positive electrode active material in which the coating film with the amorphous structure is formed on the surface of the high-potential manganese-containing lithium complex oxide, is particularly significant.

In another preferred embodiment of the lithium ion secondary battery disclosed herein, the nonaqueous electrolytic solution includes at least an organic solvent and a lithium salt including fluorine (F) as a constituent element.

Such a nonaqueous electrolytic solution has properties advantageous, in terms of obtaining a high conductivity, for a nonaqueous electrolytic solution to be used in a lithium ion secondary battery, but hydrogen fluoride (HF) can be generated by the reaction with a very small amount of water that can be present in the nonaqueous electrolytic solution, and manganese contained in the manganese-containing complex lithium oxide can be eluted into the nonaqueous electrolytic solution as a result of the reaction with the HF. Therefore, the effect demonstrated by using the configuration in accordance with the present invention, that is, the configuration in which the coating film with the amorphous structure, which excels in resistance to hydrogen fluoride, is formed on the surface of the high-potential manganese-containing lithium complex oxide, is particularly significant.

Another aspect of the present invention, which makes it possible to attain the abovementioned objective, relates to a method for manufacturing a lithium ion secondary battery including a positive electrode in which a positive electrode active material layer including at least a positive electrode active material is formed on a positive electrode collector, a negative electrode in which a negative electrode active material layer including at least a negative electrode active material is formed on a negative electrode collector, and a nonaqueous electrolytic solution. Thus, the method for manufacturing a lithium ion secondary battery, which is disclosed herein, includes: forming an electrode body including the positive electrode and the negative electrode; and accommodating in a battery case the electrode body together with the nonaqueous electrolytic solution.

In this case, the positive electrode active material formed with a film-coated positive electrode active material obtained by following processing is used: a step for preparing a mixed liquid obtained by mixing an iron-containing solution including at least one type of iron ion in an organic solvent, a fluorine-containing aqueous solution including at least one type of fluorine ion in water, and a manganese-containing lithium complex oxide including lithium and at least manganese as a transition metal element; a step for producing a precursor by removing the organic solvent and water contained in the mixed liquid; and a step for producing the film-coated positive electrode active material in which a coating film of an amorphous structure including at least iron (Fe) and fluorine (F) is formed on at least part of a surface of the manganese-containing lithium complex oxide by calcining the precursor.

With such a method, a film-coated positive electrode active material is used in which a coating film of an amorphous structure including at least iron (Fe) and fluorine (F) is formed in the advantageous form on at least part of the surface of the manganese-containing lithium complex oxide. Therefore, it is possible to obtain a lithium ion secondary battery in which the elution of manganese contained in the manganese-containing lithium complex oxide from the oxide into the nonaqueous electrolytic solution is effectively inhibited when the lithium ion secondary battery is charged and discharged.

In the preferred embodiment of the method for manufacturing the lithium ion secondary battery disclosed herein, the iron-containing solution and the fluorine-containing aqueous solution are prepared such that a molar ratio (fluorine ion/iron ion) of fluorine ions contained in the fluorine-containing aqueous solution to iron ions contained in the iron-containing solution is greater than 1 and less than 6 (preferably equal to or greater than 2 and equal to or less than 5, more preferably equal to or greater than 3 and equal to or less than 4).

With such a feature, the coating film of the preferred form can be formed on the surface of the manganese-containing lithium complex oxide. Therefore, the elution of manganese contained in the manganese-containing lithium complex oxide from the oxide into the nonaqueous electrolytic solution can be inhibited when the lithium ion secondary battery is charged and discharged, and a lithium ion secondary battery of excellent performance (excellent capacity retention ratio) can be obtained.

In the preferred embodiment of the method for manufacturing the lithium ion secondary battery disclosed herein, the step for preparing the mixed liquid includes: preparing a mixed material in which the manganese-containing lithium complex oxide is mixed with an iron-containing solution in which an iron compound including at least one type of iron ion is dissolved in an organic solvent; preparing a fluorine-containing aqueous solution in which a fluorine compound including at least one type of fluorine ion is dissolved in water; and mixing the mixed material with the fluorine-containing aqueous solution.

With such a feature, it is possible to manufacture a lithium ion secondary battery using a film-coated positive electrode active material in which the coating film of the preferred form is formed on the surface of the manganese-containing lithium complex oxide.

In the preferred embodiment of the manufacturing method disclosed herein, the mixed liquid is prepared such that the amount of the coating film is 0.5% by mass to 1.5% by mass, where the entire film-coated positive electrode active material is taken as 100% by mass.

With such a feature, the coating film of an adequate amount can be formed on the surface of the manganese-containing lithium complex oxide. Therefore, a lithium ion secondary battery with excellent performance can be manufactured.

In another preferred embodiment of the manufacturing method disclosed herein, an oxide including a layered rock salt structure or a spinel structure is used as the manganese-containing lithium complex oxide. It is preferred that an oxide including a redox potential equal to or higher than 4.6 with respect to a metallic lithium electrode be used as the manganese-containing lithium complex oxide.

In another preferred embodiment of the manufacturing method disclosed herein, the temperature at which the precursor is calcined is set to 400° C. to 550° C. With such a feature, it is possible to form, with the structure of the manganese-containing lithium complex oxide being maintained, the coating film of a preferred form on the surface the oxide.

It is preferred that the precursor be calcined in an inactive gas atmosphere. With such a feature, the coating film with the amorphous structure can be formed on the surface of the manganese-containing lithium complex oxide, without forming an iron-derived oxide that can inhibit the storage and release of lithium ions in the manganese-containing lithium complex oxide.

As described hereinabove, any of the lithium ion secondary batteries disclosed herein or lithium ion secondary batteries obtained by any of the manufacturing methods disclosed herein is provided with a film-coated positive electrode active material demonstrating excellent performance in inhibiting the elution of manganese contained in the positive electrode active material (manganese-containing lithium complex oxide) into the nonaqueous electrolytic solution during charging and discharging. Therefore, a high capacity retention ratio can be maintained in such batteries. As a consequence, such lithium ion secondary batteries can be used as a drive source for a vehicle (typically an automobile, in particular an automobile equipped with an electric motor, such as a hybrid automobile, an electric automobile, and a fuel cell automobile). Further, another aspect of the present invention relates to a vehicle equipped, as a drive source, with any of the lithium ion secondary batteries (can be in the form of a battery pack in which a plurality of batteries are typically connected in series) disclosed herein.

### BRIEF DESCRIPTION OF DRAWINGS

FIG. 1 is a perspective view illustrating schematically the external shape of the lithium ion secondary battery according to an embodiment of the present invention.

FIG. 2 is a cross-sectional view taken along the II-II line in FIG. 1,

FIG. 3 is a flowchart for explaining the method for manufacturing a film-coated positive electrode active material according to the embodiment of the present invention.

FIG. 4 shows schematically the structure of a positive electrode according to the embodiment of the present invention.

FIG. 5 is a cross-sectional TEM image showing the state of the film-coated positive electrode active material of Example 1.

FIG. 6 is a graph showing the results of EDX of the film-coated positive electrode active material of Example 1.

FIG. 7 is a graph showing the results of differential scanning calorimetry measurements (DSC) of the film-coated positive electrode active materials of Examples 1 to 4.

FIG. 8 is a graph showing a manganese precipitation concentration in the lithium ion secondary batteries of Examples 1A to 3A.

FIG. 9 is a graph showing the relationships between the coating film amount and the output ratio and between the coating film amount and the capacity retention ratio for the lithium ion secondary batteries of Examples 12 to 16.

FIG. 10 is a side view showing schematically a vehicle (automobile) provided with the lithium ion secondary battery in accordance with the present invention.

FIG. 11 is a graph showing the relationship between the molar ratio (F/Fe) of fluorine and iron and the capacity retention ratio.

FIG. 12 is a graph showing the relationship between the type of the coating film and the capacity retention ratio.

### DESCRIPTION OF EMBODIMENTS

The preferred embodiments of the present invention will be explained below. Features necessary to implement the present invention, which are other than those specifically mentioned in the present Description, can be considered as design matters for a person skilled in the art which are based on the related art in the pertinent field. The present invention can be implemented on the basis of the contents disclosed in the present Description and general technical knowledge in the pertinent filed.

As mentioned hereinabove, in the lithium ion secondary battery provided by the present invention, the positive electrode active material contained in the positive electrode is a film-coated positive electrode active material that is maim constituted by a manganese-containing lithium complex oxide including lithium and at least manganese as a transition metal element and has a coating film of an amorphous structure including at least iron (Fe) and fluorine (F) which is formed on at least part of the surface of the manganese-containing lithium complex oxide. The lithium ion secondary battery disclosed herein is explained hereinbelow in greater detail.

First, the positive electrode of the lithium ion secondary battery provided by the present invention is explained. The positive electrode disclosed herein includes a positive electrode collector and a positive electrode active material layer including at least a positive electrode active material (film-coated positive electrode active material) and formed on the positive electrode collector.

Aluminum or an aluminum-based aluminum alloy can be used, in the same manner as in a positive electrode collector used in the positive electrode of the conventional lithium ion secondary battery, as the positive electrode collector for use in the positive electrode of the lithium ion secondary battery disclosed herein. The shape of the positive electrode collector can differ according to the shape of the lithium ion secondary battery and is not particularly limited. Thus, the positive electrode collector can be in a variety of forms, such as a foil, a sheet, a rod, and a plate.

The positive electrode active material for use in the positive electrode of the lithium ion secondary battery disclosed herein is a film-coated positive electrode active material including a manganese-containing lithium complex oxide capable of reversibly storing and releasing lithium ions, and a coating film of an amorphous structure including at least iron (Fe) and fluorine (F) which is formed on at least part of a surface of the surface of the complex oxide.

Examples of the manganese-containing lithium complex oxide as the main component of the film-coated positive electrode active material include lithium-containing compounds including lithium (element) and at least manganese as a transition metal element. Examples of such compounds include LiₓMn_{y}M_{z}O₂ (here, 1≦x≦2; 0.2≦y≦1; 0≦z<1; 2≦x+y+z≦3; M is at least one element (typically, a transition metal element) selected from Co, Ni, F, B, Al, W, Mo, Cr, Ta, Nb, V, Zr, Ti, and Y), and Li₁₊ₓMn_{2-y}M_{y}O₄ (here, 0≦x≦0.3; 0≦y≦1; M is at least one element (typically, a transition metal element) selected from Co, Ni, F, B, Al, W, Mo, Cr, Ta, Nb, Zr, Ti, and Y). Specific examples include Li_{1.2}Mn_{0.54}Co_{0.13}Ni_{0.13}O₂ and LiMn_{0.33}Co_{0.33}Ni_{0.33}O₂ including a layered rock salt structure (crystal structure of a layered rock salt type), and LiMn_{1.5}Ni_{0.5}O₄ including a spinel structure. A high-potential oxide including a redox potential equal to or higher than 4.6 V with respect to a metallic lithium electrode is preferred as the manganese-containing lithium complex oxide.

The manganese-containing lithium complex oxide can be in the form of secondary particles obtained by aggregation of primary particles, with the average diameter (median diameter d50) of the secondary particles being, for example, 1 μm to 50 μm, preferably 3 μm to 10 μm. The average diameter can be easily measured by a variety of commercial particle size distribution measurement devices based on a laser diffraction and scattering method.

The coating film formed on at least part of the surface of the manganese-containing lithium complex oxide based on the film-coated positive electrode active material has an amorphous structure including at least iron (Fe) and fluorine (F). Iron (Fe(II)) with an ion valence of 2 and iron (Fe(III)) with an ion valence of 3 each can be advantageously used as the iron (Fe) constituting the coating film with the amorphous structure. For example, the coating film with the amorphous structure can include iron (Fe), fluorine (F), and oxygen (O) in the form of Fe(II)-F—O and Fe(III)-F—O.

The molar ratio (F/Fe) of fluorine (F) to iron (Fe) contained in the coating film with the amorphous structure is greater than 1 and less than 6 (preferably equal to or greater than 2 and equal to or less than 5, more preferably equal to or greater than 3 and equal to or less than 3.5). Where the molar ratio (F/Fe) is much less than 1, the amount of fluorine is too low. Therefore, the coating film with the amorphous structure including at least iron (Fe) and fluorine (F) cannot be sufficiently formed on the surface of the manganese-containing lithium complex oxide. Meanwhile, where the molar ratio (F/Fe) is much greater than 6, the amount of fluorine is too large. As a result, fluorine can react with the manganese-containing lithium complex oxide and form a fluorine compound such as LiF. Such a compound makes no contribution to charge and discharge. Therefore, the capacity retention ratio decreases.

The amount of iron element and the amount of fluorine element contained in the coating film with the amorphous structure can be detected, for example, by ICP (inductively coupled plasma) emission analysis and ion chromatography.

The amount of the coating film with the amorphous structure is preferably about 0.5% by mass to 1.5% by mass (preferably 0.8% by mass to 1.2% by mass), where the total amount of the film-coated positive electrode active material (the total amount of the manganese-containing lithium complex oxide and the coating film with the amorphous structure) is taken as 100% by mass. Where the amount of the coating film is much less than 0.5% by mass and where the amount of the coating film is much greater than 1.5% by mass, the capacity retention ratio can greatly decrease.

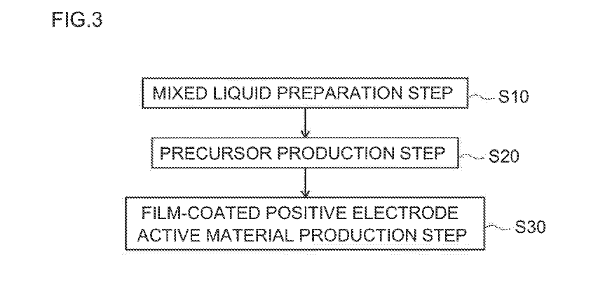

A method for manufacturing the film-coated positive electrode active material (that is a method for forming the coating film with the amorphous structure on the surface of the manganese-containing lithium complex oxide) is explained below. FIG. 3 is a flowchart for explaining a method for manufacturing the film-coated positive electrode active material according to the embodiment of the present invention.

As shown in FIG. 3, the aforementioned method includes a mixed liquid preparation step (S10), a precursor production step (S20), and a film-coated positive electrode active material production step (S30).

First, the mixed liquid preparation step (S10) is explained. The mixed liquid preparation step involves mixing an iron-containing solution including at least one type of iron ion in an organic solvent, a fluorine-containing aqueous solution including at least one type of fluorine ion in water, and a manganese-containing lithium complex oxide including lithium and at least manganese as a transition metal element.

As mentioned hereinabove, the iron-containing solution is a solution including at least one type of iron ion in an organic solvent, and can be prepared by loading an iron compound including at least one type of iron on (divalent or trivalent) into the organic solvent and performing stirring or ultrasonic treatment. For example, inorganic acid salts (for example, iron nitrate, iron sulfate, and iron chloride) or organic acid salts (for example, complexes such as iron acetate, iron citrate, iron maleate, iron ascorbate, and iron oxalate) can be used. Those salts may be used individually or in combinations of two or more thereof. For example, N,N-dimethylformamide, N-methyl-2-pyrrolidone (NMP), pyridine, N,N-dimethylacetamide, and parachlorophenol can be used individually or in appropriate combinations as the organic solvent.

As mentioned hereinabove, the fluorine-containing aqueous solution includes at least one type of fluorine ion, and this solution can be prepared by loading a fluorine compound including at least one type of fluorine ion into water (typically, iron exchange water or distilled water) and then performing stirring and ultrasonic treatment. The fluorine compound to be used is not particularly limited, provided it is a water-soluble fluorine compound containing no metal elements. For example, ammonium fluoride can be used.

The iron-containing solution and the fluorine-containing aqueous solution are preferably prepared such that the molar ratio (fluorine ion/iron ion) of fluorine ions contained in the fluorine-containing aqueous solution to iron ions contained in the iron-containing solution is greater than 1 and less than 6 (preferably equal to or greater than 2 and equal to or less than 5, and more preferably equal to or greater than 3 and equal to or less than 3.5).

As a result of mixing the iron-containing solution, the fluorine-containing aqueous solution, and the manganese-containing lithium complex oxide and performing stirring and ultrasonic treatment, a mixed liquid is prepared in which those materials are mixed. It is preferred that a mixed material be prepared in advance in which the manganese-containing lithium complex oxide is mixed with the iron-containing solution, and the mixed liquid be prepared by mixing the mixed material with the fluorine-containing aqueous solution.

The precursor production step (S20) is explained below. The precursor production step involves removing the organic solvent and water contained in the prepared mixed liquid.

A method for removing the organic solvent and water contained in the mixed liquid is not particularly limited. For example, a method of heating the mixed liquid and a method using the commercial vacuum concentration device (for example, a rotary evaporator and a flash evaporator) can be used. The temperature during heating of the mixed liquid is such (typically equal to or higher than the boiling point of the organic solvent) that the organic solvent contained in the iron-containing solution, and water contained in the fluorine-containing aqueous solution can be removed (evaporated), for example, about 170° C. to 200° C. A precursor can be produced by removing the organic solvent and water from the mixed liquid.

The fifth-dated positive electrode active material production step (S30) is explained below. The file-coated positive electrode active material production step involves calcining the precursor.

By calcining the precursor, it is possible to produce a film-coated positive electrode active material in which a coating film of an amorphous structure including at least iron (Fe) and fluorine (F) is formed on at least part of a surface of the manganese-containing lithium complex oxide.

The temperature at which the precursor is calcined is preferably, for example, about 400° C. to 550° C. (for example, 450° C.). Where the calcination temperature is much lower than 400° C., impurities can be included in the produced film-coated positive electrode active material. Further, where the calcination temperature is much higher than 550° C., a transition metal element contained in the manganese-containing lithium complex oxide which is the main component of the film-coated positive electrode active material can participate in a reaction and the oxide structure can collapse.

Further, when the precursor is calcined, it is preferred that the calcination be performed in an inactive gas atmosphere of argon gas or nitrogen gas. By calcining the precursor in the inactive gas atmosphere, it is possible to inhibit a shift in the composition ratio of the manganese-containing lithium complex oxide caused by diffusion of the iron (Fe) component into the precursor and to form the film with the amorphous structure on the surface of the manganese-containing lithium complex oxide.

The positive electrode active material layer can include, as necessary, any components such as an electrically conductive material and a binding material (binder) in addition to the film-coated positive electrode active material.

The electrically conductive material is not particularly limited and materials that have been conventionally used in positive electrodes of lithium ion secondary batteries of this type can be used. For example, a carbon material such as a carbon powder and carbon fibers can be used. Various types of carbon black (for example, acetylene black, furnace black, and Ketjen black), and carbon powers such as graphite powders can be used as the carbon powder. Those materials may be used individually or in combinations of two or more thereof. The amount of the electrically conductive material used is not particularly limited. For example, the electrically conductive material can be used at 1% by mass to 20% by mass (preferably 5% by mass to 15% by mass) with respect to 100% by mass of the film-coated positive electrode active material.

Binding materials similar to those used in the positive electrodes of typical lithium ion secondary batteries can be used, as appropriate, as the abovementioned binding material (binder). For example, when a paste-like composition (a paste-like composition is inclusive of a slurry-like composition and an ink-like composition) of a solvent system is used as a composition for forming the positive electrode active material layer, a polymer material soluble in an organic solvent (nonaqueous solvent), such as polyvinylidene fluoride (PVDF) and polyvinylidene chloride (PVDC) can be used. Alternatively, where a paste-like composition of an aqueous system is used, a polymer material soluble or dispersible in water can be advantageously used. Examples of such materials include polytetrafluoroethylene (PTFE) and carboxymethyl cellulose (CMC). The polymer materials presented hereinbelow by way of example can be used not only as the binding material, but also as other additives to the composition, such as a thickening agent. The amount of the binding material used is not particularly limited, and the binding material can be used in an amount of 0.5% by mass to 10% by mass per 100% by mass of the film-coated positive electrode active material.

The “paste-like composition of a solvent system”, as referred to herein, is a general concept indicating a composition in Which the dispersion medium of a film-coated positive electrode active material is mainly an organic solvent. For example, N-methyl-2-pyrrolidone (NMP) can be used as the organic solvent. The “paste-like composition of an aqueous system”, as referred to herein, is a general concept indicating a composition in which water or a water-based mixed solvent is used as the dispersion medium of a film-coated positive electrode active material. An organic solvent (a lower alcohol, a lower ketone, or the like) capable of mixing homogeneously with water, or two or more such solvents can be selected, as appropriate, as a solvent other than water, which constitutes the aforementioned mixed solvent.

The positive electrode of the lithium ion secondary battery disclosed herein can be produced, for example, in the following manner. A paste-like composition for forming a positive electrode active material layer is prepared (purchased, or the like) in which the film-coated positive electrode active material and any other component (electrically conductive material, a binding material, and the like) are dispersed in an appropriate solvent. The prepared composition is then coated on (applied to) the surface of the positive electrode collector, and the composition is dried to form the positive electrode active material layer, followed by optional compression (pressing). As a result, it is possible to produce a positive electrode including the positive electrode collector and the positive electrode active material layer formed on the positive electrode collector.

A technique similar to the conventional well-known methods can be used, as appropriate, for coating the composition on the positive electrode collector. For example, the composition can be advantageously coated on the positive electrode collector by using an appropriate coating device such as a die coater, a slit coater, and a gravure coater. The conventional well-known compression method such as roll pressing method and flat plate pressing method can be used for the compression (pressing).

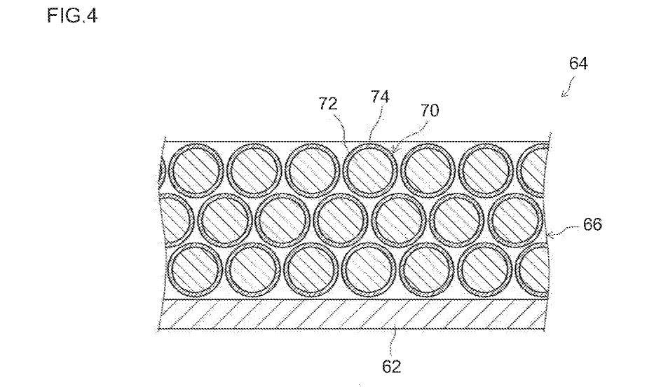

As shown in FIG. 4, a positive electrode 64 produced in the above-described manner is provided with a positive electrode collector 62 and a positive electrode active material layer 66 formed on the collector 62 and including at least a film-coated positive electrode active material 70. The film-coated positive electrode active material 70 contained in the positive electrode active material layer 66 is a positive electrode active material including a coating film 74 of an amorphous structure that is formed on at least part of the surface of a manganese-containing lithium complex oxide 72 and includes at least iron (Fe) and fluorine (F). Therefore, the elution of manganese contained in manganese-containing lithium complex oxide from the oxide into the nonaqueous electrolytic solution when the lithium ion secondary battery is charged and discharged can be inhibited. Further, since the coating film 74 is formed, the heat generation initiation temperature of the film-coated positive electrode active material 70 is higher, the amount of heat generated thereby is lower, and thermal stability is superior to those in the positive electrode active material including no coating film. The depiction of an electrically conductive material, a binding material, and the like in FIG. 4 is omitted.

The negative electrode provided in the lithium ion secondary battery disclosed herein is explained below. The negative electrode includes a negative electrode collector and a negative electrode active material layer that is formed on the negative electrode collector and includes at least a negative electrode active material.

A material that has been conventionally used for negative electrodes of lithium ion secondary batteries, or two or more such materials can be used without any particular limitation as the negative electrode active material. Examples of suitable materials include carbon materials such as graphite, oxide materials such as a lithium titanium oxide (Li₄Ti₅O₁₂), and a metal material constituted by a metal such as tin, aluminum (Al), zinc (Zn), and silicon (Si), or a metallic alloy based on those metal elements.

The negative electrode active material layer can include, as necessary, any components such as a binding material (binder) and a thickening material in addition to the negative electrode active material.

A binding material similar to those that are used for negative electrodes of typical lithium ion secondary batteries can be used, as appropriate, as the abovementioned binding material. For example, where a paste-like composition of an aqueous system is used for forming the negative electrode active material layer, a polymer material soluble or dispersible in water can be advantageously used. Examples of polymer materials dispersible in water (water-dispersible materials) include rubbers such as a styrene-butadiene rubber (SBR) and a fluorine rubber; polyethylene oxide (PEO) and fluororesins such as polytetrafluoroethylene; and vinyl acetate copolymers.

A polymer material dissolvable or dispersible in water or a solvent (organic solvent) can be used as the aforementioned thickening material. Examples of polymer materials soluble in water (water-soluble polymer materials) include cellulose polymers such as carboxymethyl cellulose (CMC), methyl cellulose (MC), cellulose acetate phthalate (CAP), and hydroxypropyl methylcellulose (HPMC), and polyvinyl alcohol (PVA).

The negative electrode active material layer is formed, for example, by preparing (purchasing, or the like) a paste-like composition for forming a negative electrode active material layer in which the negative electrode active material and any other component (a binding material, a thickening material, and the like) are dispersed in an appropriate solvent (for example, water), coating the prepared composition on (applying to) the surface of the negative electrode collector, drying the composition, and then compressing (pressing), as necessary. As a result, it is possible to produce a negative electrode including the negative electrode collector and the negative electrode active material layer.

An embodiment of the lithium ion secondary battery provided with the positive electrode and negative electrode disclosed herein is explained hereinbelow with reference to the appended drawings, but the present invention is not intended to be limited to this embodiment. Thus, the form (shape or size) of the produced lithium ion secondary battery is not particularly limited, provided that the abovementioned positive electrode is used. In the below-described embodiment, a lithium ion secondary battery of a configuration in which a wound electrode body and an electrolytic solution are accommodated in an angular battery case is explained by way of example.

In the figures below, members and parts demonstrating like effects are denoted by like reference numerals and redundant explanation thereof is herein omitted. The dimensional relationships (length, width, thickness, and the like) in the figures do not necessarily reflect the actual dimensional relationships,

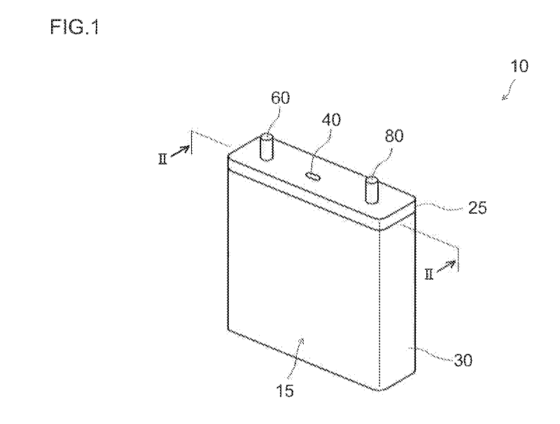

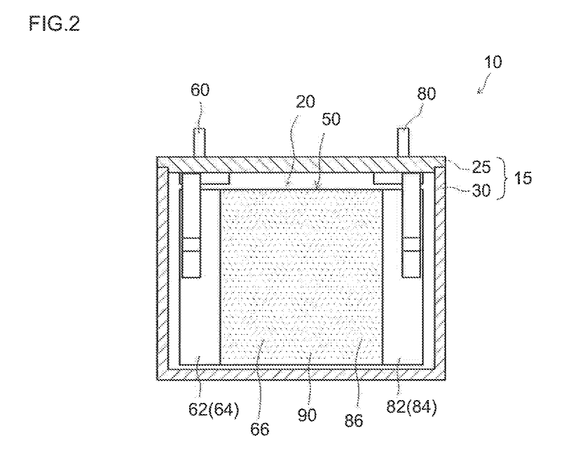

FIG. 1 is a perspective view showing schematically a lithium ion secondary battery (nonaqueous electrolyte secondary battery) 10 according to the present embodiment. FIG. 2 is a vertical sectional view taken along the II-II line in FIG. 1.

As shown in FIG. 1, the lithium ion secondary battery 10 according to the present embodiment is provided with a metallic battery case 15 (a resin or laminated film battery case can be also advantageously used). The case (outer container) 15 is provided with a case main body 30 of a flat rectangular parallelepiped shape with an open upper end and a lid 25 closing an opening 20 thereof. The opening 20 of the case main body 30 is sealed with the lid 25 by welding or the like. A positive electrode terminal 60 electrically connected to a positive electrode 64 of a wound electrode body 50 and a negative electrode terminal 80 electrically connected to a negative electrode 84 of the wound electrode body 50 are provided at the upper surface (that is, the lid 25) of the case 15. Further, the lid 25 is provided with a safety valve 40 for discharging to the outside of the case 15 a gas generated inside the case 15 during battery abnormality, in the same manner as in the case of the conventional lithium ion secondary battery. The flattened wound electrode body 50 and an electrolytic solution are accommodated inside the case 15. The wound electrode body 50 is fabricated by laminating the sheet-shaped positive electrode 64 and the sheet-shaped negative electrode 84 with a total of two separators 90, winding the laminate in the longitudinal direction, and then collapsing the obtained wound body from the side surface direction.

During the lamination, as shown in FIG. 2, the positive electrode 64 and the negative electrode 84 are overlapped with a certain displacement in the width direction, such that the positive electrode active material layer non-formation portion of the positive electrode 64 that is, a portion where the positive electrode active material layer 66 is not formed and the positive electrode collector 62 is exposed) and the negative electrode active material layer non-formation portion of the negative electrode 84 (that is, a portion where the negative electrode active material layer 86 is not formed and the positive electrode collector 82 is exposed) project from respective sides of the separator 90 in the width direction. As a result, the electrode active material layer non-formation portions of the positive electrode 64 and the negative electrode 84 project to the outside from the respective winding core portion (that is, a portion where the positive electrode active material layer 66 of the positive electrode 64, the negative electrode active material layer 86 of the negative electrode 84, and the two separators 90 are tightly wound together) in the transverse direction with respect to the winding direction of the wound electrode body 50. As shown in FIG. 2, the positive electrode terminal 60 is joined to the positive electrode active material layer non-formation portion, and the positive electrode terminal 60 and the positive electrode 64 of the wound electrode body 50 formed in the above-mentioned flattened shape are electrically connected. Likewise, the negative electrode terminal 80 is joined to the negative electrode active material layer non-formation portion, and the negative electrode terminal 80 and the negative electrode 84 are electrically connected. The positive and negative electrode terminals 60, 80 and the positive and negative electrode collectors 62, 82 can be joined together, for example, by ultrasonic welding or resistance welding.

A nonaqueous electrolytic solution similar to that conventionally used for a lithium ion secondary battery can be used without any particular limitation as the abovementioned nonaqueous electrolytic solution. Such a nonaqueous electrolytic solution typically has a composition including a support salt in an appropriate organic solvent (nonaqueous solvent). For example, one, or two or more solvents selected from ethylene carbonate (EC), propylene carbonate (PC), dimethyl carbonate (DMC), diethyl carbonate (DEC), and ethyl methyl carbonate (EMC) can be used as the organic solvent. For example, it is preferred that a lithium salt including fluorine (F) as a constituent element, such as LiPF₆, LiBF₄, LiAsF₆, Li(CF₃SO₂)₂N, and LiCFSO₃, be used as the support salt (support electrolyte). A difluorophosphate (LiPO₂F₂) or lithium bis-oxalate borate (LiBOB) may be dissolved in the nonaqueous electrolytic solution.

The conventional well-known separators can be used without any particular limitation as the above-mentioned separator. For example, a porous sheet (fine porous resin sheet) constituted by a resin can be advantageously used. A porous polyolefin resin sheet such as polyethylene (PE) sheet or a polypropylene (PP) sheet, is preferred. For example, a PE sheet, a PP sheet, and a sheet including a three-layer structure (PP/PE/PP structure) in which a PP layer is laminated on each side of a PE layer can be advantageously used.

### EXAMPLES

Examples of the present embodiment are explained below, but the present invention is not intended to be limited to those examples.

### Fabrication of Lithium Ion Secondary Battery

### Example 1

A mixed material according to Example 1 was prepared by charging 0.075 g of iron (II) acetate as an iron compound into N,N-dimethylformamide as an organic solvent, dissolving by stirring and ultrasonic treatment to obtain an iron-containing solution, and admixing 4 g of Li_{1.2}Mn_{0.54}Co_{0.13}Ni_{0.13}O₂ as a manganese-containing lithium complex oxide (positive electrode active material).

Then, 0.032 g of ammonium fluoride as a fluorine compound was charged into ion-exchange water and dissolved by performing stirring and ultrasonic treatment to prepare a fluorine-containing aqueous solution according to Example 1.

A precursor was then produced by removing (vaporizing) N,N-dimethylformamide and ion-exchange water from the mixed liquid in which the mixed material according to Example 1 was mixed with the fluorine-containing aqueous solution according to Example 1, while stirring at 180° C. A film-coated positive electrode active material according to Example 1 was then obtained by calcining the precursor for 10 h at 450° C. in an inactive gas atmosphere (argon gas) and forming a coating film (Fe(II)-F—O) including at least iron and fluorine on the surface of the manganese-containing lithium complex oxide (positive electrode active material).

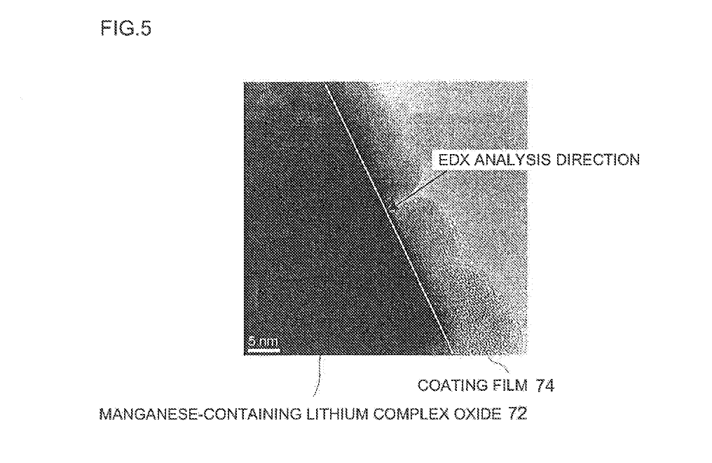

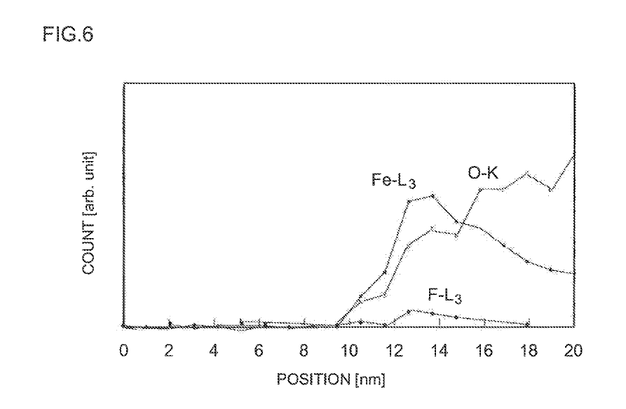

Transmission electron microscope (TEM) observations and an energy dispersive X-ray spectroscopy (EDX) were then performed with respect to the film-coated positive electrode active material according to Example 1. FIG. 5 shows a cross-sectional TEM image showing the surface state of the film-coated positive electrode active material according to Example 1. As shown in FIG. 5, a coating film 74 was formed on the surface of the manganese-containing lithium complex oxide 72, and the structure of the coating film 74 was confirmed to be amorphous. FIG. 6 is a graph showing the results of the EDX analysis of the film-coated positive electrode active material according to Example 1. As shown in FIG. 6, the coating film 74 (see FIG. 5) was confirmed to include iron (Fe), fluorine (F), and oxygen (O).

A paste-like composition for positive electrode active material layer formation according to Example 1 was then prepared by weighing the film-coated positive electrode active material according to Example 1, acetylene black (AB) as an electrically conductive material, and PVDF as a binding material to obtain a mass ratio of 85:10:5 and dispersing those materials in NMP. The composition was coated on a positive electrode collector (aluminum foil) with a thickness of 15 μm to obtain a two-side coating amount of 6.4 mg/cm², and the coated composition was dried to form a positive electrode active material layer. A positive electrode in which the positive electrode active material layer was formed on the positive electrode collector was obtained by pressing with a rolling press machine to a density of the positive electrode active material layer of 2.45 g/cm³. Finally, the positive electrode according to Example 1 was fabricated by cutting the positive electrode to a diameter of 16 mm.

A lithium ion secondary battery (a coin cell of a CR2032 type) was fabricated by using the positive electrode according to Example 1 and a negative electrode constituted from metallic lithium and having a diameter of 19 mm and a thickness of 35 μm. A polyethylene porous separator was used in the fabrication process. A nonaqueous electrolytic solution of a composition obtained by dissolving LiPF₆ at 1 mol/L as a support salt in a mixed solvent including ethylene carbonate (EC) and diethyl carbonate (DEC) at a ratio (volume ratio) of 1:1 was used as the nonaqueous electrolytic solution.

### Example 2

A mixed material according to Example 2 was prepared by charging 0.1092 g of iron (III) nitrate nonahydrate as an iron compound into N,N-dimethylformamide as an organic solvent, dissolving by stirring and ultrasonic treatment to obtain an iron-containing solution, and admixing 4 g of Li_{1.2}Mn_{0.54}Co_{0.13}O₂ as a manganese-containing lithium complex oxide (positive electrode active material). A lithium ion secondary battery according to Example 2 was fabricated in the same manner as in Example 1, except that the mixed material according to Example 2 was used. In the film-coated positive electrode active material according to Example 2, a coating film (Fe(III)-F—O) of an amorphous structure including at least iron and fluorine was formed on the surface of the manganese-containing lithium complex oxide (positive electrode active material).

### Example 3

A paste-like composition for positive electrode active material layer formation according to Example 3 was prepared by weighing Li_{1.2}Mn_{0.54}Co_{0.13}Ni_{0.13}O₂ as a manganese-containing lithium complex oxide (positive electrode active material), acetylene black (AB), and PVDF to obtain a mass ratio of 85:10:5 and dispersing those material in NMP. A lithium ion secondary battery according to Example 3 was fabricated in the same manner as in Example 1, except that the composition according to Example 3 was used.

### Example 4

A mixed solution was prepared by dissolving 0.11 g of aluminum nitrate and 0.21 g of ammonium fluoride in distilled water. A mixed liquid according to Example 4 was prepared by charging in N,N-dimethylformamide 4 g of Li_{1.2}Mn_{0.54}Co_{0.13}Ni_{0.13}O₂ as a manganese-containing lithium complex oxide (positive electrode active material) and then admixing the prepared mixed solution. A film-coated positive electrode active material according to Example 4 was obtained in the same manner as in Example 1, except that the mixed liquid according to Example 4 was used. In the film-coated positive electrode active material according to Example 4, a coating film of aluminum fluoride (AlF₃) was formed on the surface of the manganese-containing lithium complex oxide (positive electrode active material). The mass ratio of the positive electrode active material and AlF₃ in this case was 99:1.

A paste-like composition for positive electrode active material layer formation according to Example 4 was prepared by weighing the film-coated positive electrode active material according to Example 4, acetylene black (AB), and PVDF to obtain a mass ratio of 85:10:5 and dispersing those materials in NMP. A lithium ion secondary battery according to Example 4 was fabricated in the same manner as in Example 1, except that the composition according to Example 4 was used.

### Example 5

A mixed material according to Example 5 was prepared by charging 0.08 g of titanium (IV) ethoxide as a titanium compound into N,N-dimethylformamide, dissolving by stirring and ultrasonic treatment, and admixing 4 g of Li_{1.2}Mn_{0.54}Co_{0.13}Ni_{0.13}O₂ as a manganese-containing lithium complex oxide (positive electrode active material). A lithium ion secondary battery according to Example 5 was fabricated in the same manner as in Example 1, except that the mixed material according to Example 5 was used instead of the mixed material according to Example 1, in the film-coated positive electrode active material according to Example 5, a coating film (Ti(IV)-F—O) of an amorphous structure including at least titanium and fluorine was formed on the surface of the manganese-containing lithium complex oxide (positive electrode active material).

### Example 6

A mixed material according to Example 6 was prepared by charging 0.075 g of iron (II) acetate into N,N-dimethylformamide, dissolving by stirring and ultrasonic treatment to obtain an iron-containing solution, and admixing 4 g of LiMn_{0.33}Co_{0.33}Ni_{0.33}O₂ as a manganese-containing lithium complex oxide (positive electrode active material). A lithium ion secondary battery according to Example 6 was fabricated in the same manner as in Example 1, except that the mixed material according to Example 6 was used,

### Example 7

A mixed material according to Example 7 was prepared by charging 0.1092 g of iron (III) nitrate nonahydrate into N,N-dimethylformamide, dissolving by stirring and ultrasonic treatment to obtain an iron-containing solution, and admixing 4 g of LiMn_{0.33}Co_{0.33}Ni_{0.33}O₂ as a manganese-containing lithium complex oxide (positive electrode active material). A lithium ion secondary battery according to Example 7 was fabricated in the same manner as in Example 1, except that the mixed material according to Example 7 was used.

### Example 8

A lithium ion secondary battery according to Example 8 was fabricated in the same manner as in Example 3, except that LiMn_{0.33}Co_{0.33}Ni_{0.33}O₂ was used as the manganese-containing lithium complex oxide (positive electrode active material),

### Example 9

A lithium ion secondary battery according to Example 9 was fabricated in the same manner as in Example 4, except that LiMn_{0.33}Co_{0.33}Ni_{0.33}O₂ was used as the manganese-containing lithium complex oxide (positive electrode active material).

### Example 10

A mixed material according to Example 10 was prepared by charging 0.075 g of iron (ID acetate into N,N-dimethylformamide, dissolving by stifling and ultrasonic treatment to obtain an iron-containing solution, and admixing 4 g of LiMn_{1.5}Ni_{0.5}O₄ as a manganese-containing lithium complex oxide (positive electrode active material). A lithium ion secondary battery according to Example 10 was fabricated in the same manner as in Example 1, except that the mixed material according to Example 10 was used.

### Example 11

A paste-like composition for positive electrode active material layer formation according to Example 11 was prepared by weighing LiMn_{1.5}Ni_{0.5}O₄ as a manganese-containing lithium complex oxide (positive electrode active material), acetylene black (AB), and PVDF to obtain a mass ratio of 85:10:5 and dispersing those materials in NMP. A lithium ion secondary battery according to Example 11 was fabricated in the same manner as in Example 1, except that the composition according to Example 11 was used. Features of the lithium ion secondary batteries according to Examples 1 to 11 are shown in Table 1.

TABLE 1

| | | | | Heat | |
|---|---|---|---|---|---|
| | | | | generation | Heat |
| | | | Capacity | initiation | generation |
| | Manganese-containing | | retention | temperature | amount |
| Example | lithium complex oxide | Coating film | ratio (%) | (° C.) | (kJ/g) |
| 1 | Li_{1.2}Mn_{0.54}Co_{0.13}Ni_{0.13}O₂ | Fe(II)—F—O | 94 | 201.1 | 0.24 |
| 2 | Li_{1.2}Mn_{0.54}Co_{0.13}Ni_{0.13}O₂ | Fe(III)—F—O | 91 | 245.9 | 0.55 |
| 3 | Li_{1.2}Mn_{0.54}Co_{0.13}Ni_{0.13}O₂ | None | 76 | 182.3 | 1.48 |
| 4 | Li_{1.2}Mn_{0.54}Co_{0.13}Ni_{0.13}O₂ | AlF₃ | 85 | 197.4 | 0.56 |
| 5 | Li_{1.2}Mn_{0.54}Co_{0.13}Ni_{0.13}O₂ | Ti—F—O | 71 | 202.7 | 0.89 |
| 6 | LiMn_{0.33}Co_{0.33}Ni_{0.33}O₂ | Fe(II)—F—O | 91 | 280.2 | 0.91 |
| 7 | LiMn_{0.33}Co_{0.33}Ni_{0.33}O₂ | Fe(III)—F—O | 90 | 282.3 | 0.84 |
| 8 | LiMn_{0.33}Co_{0.33}Ni_{0.33}O₂ | None | 77 | 239.9 | 1.23 |
| 9 | LiMn_{0.33}Co_{0.33}Ni_{0.33}O₂ | AlF₃ | 83 | 252.6 | 1.03 |
| 10 | LiMn_{1.5}Ni_{0.5}O₄ | Fe(II)—F—O | 92 | 256.7 | 0.88 |
| 11 | LiMn_{1.5}Ni_{0.5}O₄ | None | 82 | 236.9 | 1.69 |

[Initial Charge and Discharge Treatment]

The operation of charging at a constant current (CC) to 4.8 V at a charge rate of C/3 of the theoretical capacity of the positive electrode and the operation of discharging at a constant current to 2.5 V at a discharge rate of C/3 were repeatedly performed three times with respect to the fabricated lithium ion secondary batteries according to Examples 1 to 9. Here, 1 C means a current amount at which a battery capacity (Ah) estimated from the theoretical capacity of the positive electrode can be charged over 1 h.

The operation of charging at a constant current (CC) to 5 V at a charge rate of C/3 of the theoretical capacity of the positive electrode and the operation of discharging at a constant current to 4.3 V at a discharge rate of C/3 were repeatedly performed three times with respect to the fabricated lithium ion secondary batteries according to Examples 10 and 11.

[Charge and Discharge Cycle Test]

A total of 30 charge and discharge cycles were repeated and the capacity retention ratio (%) after 30 cycles was determined with respect to the lithium ion secondary batteries of Examples 1 to 11 after the initial charge and discharge treatment. Thus, charge and discharge conditions of 1 cycle for the lithium ion secondary batteries according to Examples 1 to 9 included constant-current and constant-voltage charging (CCCV charging) to a voltage of 4.8 V at a charge rate of 2 C and then constant-current discharging to a voltage of 2.5 V at a discharge rate of 2 C at a measurement temperature of 25° C. Meanwhile, charge and discharge conditions of 1 cycle for the lithium ion secondary batteries according to Examples 10 and 11 included constant-current and constant-voltage charging (CCCV charging) to a voltage of 5 V at a charge rate of 2 C and then constant-current discharging to a voltage of 4.3 V at a discharge rate of 2 C at a measurement temperature of 25° C. The discharge capacity of the first cycle and the discharge capacity of the thirtieth cycle were measured in each example. A ratio ((discharge capacity after 30 cycles)/(initial capacity)×100(%)) of the discharge capacity after 30 cycles to the discharge capacity after 1 cycle (initial capacity) was calculated as the capacity retention ratio (%). The measurement results are shown in Table 1.

As shown in Table 1, the capacity retention ratio of the configuration in which a coating film of an amorphous structure including at least iron and fluorine was formed on the surface of a manganese-containing lithium complex oxide was confirmed to have increased over that of the configuration including no coating film (Examples 1 to 3; Examples 6 to 8; Examples 10 and 11). Further, the capacity retention ratio of the coating film of an amorphous structure including at least iron and fluorine was confirmed to have increased over that of the coating film including other transition metal elements (Examples 1, 2, 4, and 5; Examples 6, 7, and 9).

[Differential Scanning Calorimetry]

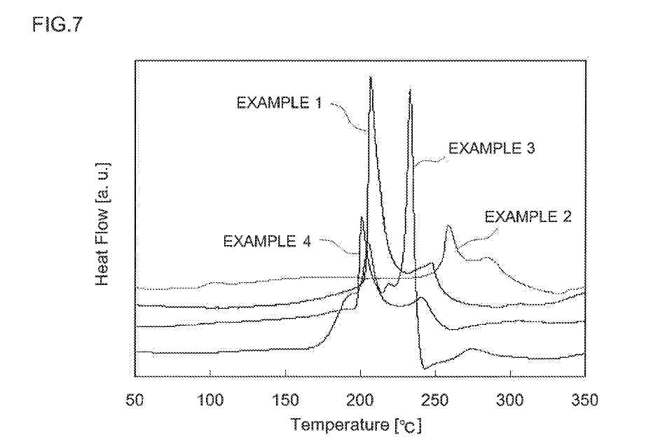

The lithium ion secondary batteries according to Examples 1 to 11 were charged to an upper limit voltage (4.8 V in Examples 1 to 9 and 5 V in Examples 10 and 11), the secondary batteries in a fully charged state (SOC(State of Charge) 100%) were disassembled and the film-coated positive electrode active material was taken out. Differential scanning calorimetry (DSC) was performed with respect to each film-coated positive electrode active material. More specifically, the differential scanning calorimetry was performed by using a DSC device (model “DSC-60” manufactured by Shimazu Corp.) and changing the temperature from 50° C. to 350° C. at a temperature rise rate of 5° C./min under a nitrogen atmosphere. FIG. 7 is a graph (DSC curve) showing the results of differential scanning calorimetry of the film-coated positive electrode active materials according to Examples 1 to 4. The heat generation initiation temperature (° C.) was determined from the tangent at the initial peak of the DSC curve, and the amount of generated heat (kJ/g) was determined from the area of the DSC curve from 50° C. to 350° C. The measurement results are shown in Table 1.

As shown in Table 1, the heat generation initiation temperature of the configuration in which a coating film of an amorphous structure including at least iron and fluorine was formed on the surface of a manganese-containing lithium complex oxide was confirmed to have increased and the amount of generated heat was confirmed to have decreased greatly with respect to those of the configuration including no coating film (Examples 1 to 3; Examples 6 to 8; Examples 10 and 11). Further, the heat generation initiation temperature of the coating film of an amorphous structure including at least iron and fluorine was confirmed to have increased, or the amount of generated heat was confirmed to have decreased, or the heat generation initiation temperature was confirmed to have increased and the amount of generated heat was confirmed to have decreased over those of the coating film including other transition metal elements (Examples 1, 2, 4, and 5; Examples 6, 7, and 9). Thus, the film-coated positive electrode active material in which a coating film of an amorphous structure including at least iron and fluorine is formed on the surface of the manganese-containing lithium complex oxide excels in thermal stability and is less likely to demonstrate failures at a high temperature than the conventional positive electrode active material.

### Manganese Precipitate Concentration Measurement

### Example 1A

A paste-like negative electrode composition for negative electrode active material layer formation was prepared by weighing natural graphite as a negative electrode active material, a SBR as a binder, and CMC, as a thickening material to obtain a mass ratio of 98:1:1 and those materials were dispersed in ion-exchange water. A negative electrode in which a negative electrode active material layer was formed on a negative electrode collector was fabricated by coating the composition on both surfaces of the negative electrode collector (copper foil) with a thickness of 10 μm and drying the composition.

A lithium ion secondary battery according to Example 1A was fabricated in the same manner as in Example 1, except that the ahovementioned fabricated negative electrode was used.

### Example 2A

A lithium ion secondary battery according to Example 2A was fabricated in the same manner as in Example 1A, except that the film-coated positive electrode active material according to Example 2 was used.

### Example 3A

A lithium ion secondary battery according to Example 3A was fabricated in the same manner as in Example 1A, except that the composition according to Example 3 was used.

The treatment same as the initial charge and discharge treatment performed with respect to the lithium ion secondary batteries according to Examples 1 to 9 was performed with respect to the lithium ion secondary batteries according to Examples 1A to 3A.

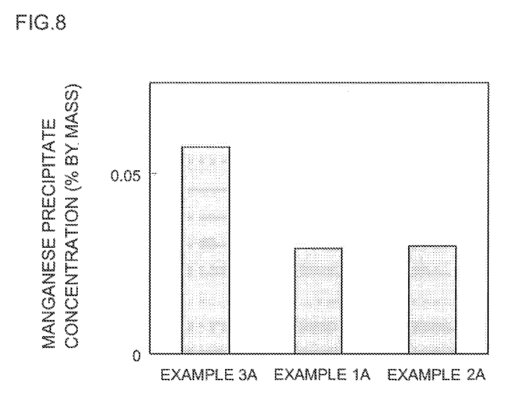

The lithium ion secondary batteries of Examples 1A to 3A alter the initial charge and discharge treatment were disassembled and the negative electrodes and separators were taken out. The negative electrodes and separators were washed with ethylene carbonate and loaded into 100 ml of aqua regia. The ICE emission analysis was performed with respect to the solution, and a manganese precipitate concentration (% by mass), which is the concentration of manganese that has been eluted from the manganese-containing lithium complex oxide (in this case Li_{1.2}Mn_{0.54}Co_{0.13}Ni_{0.13}O₂) and precipitated on the negative electrode and separator, was measured. The manganese precipitate concentration, as referred to herein, is the amount of Mn precipitate (g) related to the total amount of the negative electrode active material (g). The measurement results are shown in FIG. 8.

As shown in FIG. 8, the manganese precipitate concentration in the lithium ion secondary batteries provided with the coating film (Fe(II)-F—O) of Example 1A and the coating film (Fe(III)-F—O) of Example 2A was confirmed to have decreased to half or less of that in the lithium ion secondary battery compared to Example 3A which was not provided with the coating film,

### Example 12

A mixed material according to Example 12 was prepared by admixing 4 g of Li_{1.2}Mn_{0.54}Co_{0.13}Ni_{0.13}O₂ as a manganese-containing lithium complex oxide (positive electrode active material) to a solution obtained by charging 0.075 g of iron (II) acetate into N,N-dimethylformamide and performing stirring and ultrasonic treatment.

A fluorine-containing aqueous solution according to Example 12 was prepared by loading 0.032 g of ammonium fluoride as a fluorine compound into ion exchange water and performing stirring and ultrasonic treatment.

A precursor was produced by removing (evaporating) N,N-dimethylformamide and ion-exchange water while stirring at 180° C. a mixed liquid obtained by mixing the mixed material according to Example 12 and the fluorine-containing aqueous solution according to Example 12. A film-coated positive electrode active material according to Example 12 in which a coating film (Fe(II)-Fe—O) of an amorphous structure including at least iron and fluorine was formed on the surface of the manganese-containing lithium complex oxide (positive electrode active material) was obtained by calcining the precursor for 10 h at 450° C. in an inactive gas atmosphere (argon gas).

The amount of the coating film (Fe(II)F—O) was 1% by mass, where the total amount of the film-coated positive electrode active material (that is, the total amount of the manganese-containing lithium complex oxide and the coating film) according to Example 12 was taken as 100% by mass. A lithium ion secondary battery according to Example 12 was fabricated in same manner as in Example 1, except that the film-coated positive electrode active material according to Example 12 was used.

### Examples 13 to 16

Lithium ion secondary batteries according to Examples 13 to 16 were then fabricated. In the lithium ion secondary batteries according to Examples 13 to 16, the amount of the coating film formed on the surface of the manganese-containing lithium complex oxide was changed by adjusting the amount of iron (II) acetate and ammonium fluoride used when producing the film-coated positive electrode active material according to each example. The features of the lithium ion secondary batteries according to Examples 12 to 16 are shown in Table 2.

TABLE 2

| | | Amount of | Amount of | Capacity | |
|---|---|---|---|---|---|
| | Amount of | iron (II) | ammonium | retention | Output |
| | coating film | acetate | fluoride | ratio | ratio |
| Example | (% by mass) | used (g) | used (g) | (%) | (%) |
| 12 | 0.03 | 0.0022 | 0.001 | 75 | 70 |
| 13 | 0.3 | 0.022 | 0.01 | 79 | 68 |
| 14 | 0.5 | 0.038 | 0.016 | 90 | 60 |
| 15 | 1.0 | 0.075 | 0.032 | 94 | 59 |
| 16 | 2.0 | 0.152 | 0.065 | 85 | 40 |

[Charge and Discharge Cycle Test]

The initial charge and discharge treatment and charge and discharge cycle test were performed and the capacity retention ratio (%) after 30 cycles was determined with respect to the fabricated lithium ion secondary batteries according to Examples 12 to 16 under the same conditions as with respect to the lithium ion secondary batteries according to Examples 1 to 11. The measurement results are shown in Table 2 and FIG. 9.

[Evaluation of Output Characteristics]

The initial charge and discharge treatment was performed with respect to the fabricated lithium ion secondary batteries according to Examples 12 to 16 under the same conditions as with respect to the lithium ion secondary batteries according to Examples 1 to 11. Then, the constant-current charge (CC charge) was performed to a voltage of 4.3 V at a charge rate of 1 C and then the constant-current discharge was performed to a voltage of 2.5 V at a discharge rate of 20 C at a measurement temperature of 25° C. The capacity obtained in this case was taken as a 20 C discharge capacity. Further, the constant-current charge (CC charge) was performed to a voltage of 4.3 V at a charge rate of 1 C and then the constant-current discharge was performed to a voltage of 2.5 V at a discharge rate of 1 C at a measurement temperature of 25° C. The capacity obtained in this case was taken as a 1 C discharge capacity. The output ratio (%) was determined by the following formula: ((20 C discharge capacity)/(1 C discharge capacity)×100). The output ratios of the secondary batteries according to the examples are shown in Table 2 and FIG. 9.

As shown in Table 2 and FIG. 9, the output ratio was confirmed to decrease with the increase in the amount of the coating film. Meanwhile, the capacity retention ratio was confirmed to be the best at the amount of the coating film of 1% by mass. The capacity retention ratio was confirmed to decrease greatly at the amount of coating film less than 0.5% by mass and greater than 1.5% by mass. It follows from the above, that the preferred amount of the coating film was confirmed to be 0.5% by mass to 1.5% by mass (for example, 0.8% by mass to 1.2% by mass), where the total amount of the film-coated positive electrode negative electrode was taken as 100% by mass.

According to the abovementioned test results, the lithium ion secondary batteries provided with the Fe(II)-F—O and Fe(III)-F—O coating films were confirmed to excel in battery performance (capacity retention ratio). It was then investigated how the capacity retention ratio of the lithium ion secondary battery changes depending on the molar ratio of iron and fluorine in the coating film with the amorphous structure including iron (Fe) and fluorine (F).

### Fabrication of Lithium Ion Secondary Battery

### Example 2-1

A lithium ion secondary battery according to Example 2-1 was fabricated in the same manner as in Example 1, except that the iron-containing solution and fluorine-containing aqueous solution were prepared such that the molar ratio of the fluorine ion contained in the fluorine-containing aqueous solution and the iron ion contained in the iron-containing solution was 1:3 (that is, the (fluorine ion/iron ion) molar ratio was 3). In this case, the molar ratio (F/Fe) of fluorine and iron contained in the coating film (Fe(II)-F—O) with the amorphous structure was 3.

### Example 2-2

A lithium ion secondary battery according to Example 2-2 was fabricated in the same manner as in Example 1, except that no fluorine-containing aqueous solution as used, in the film-coated positive electrode active material according to Example 2-2, a coating film (Fe(II)O) of an amorphous structure including at least iron was formed on the surface of the manganese-containing lithium complex oxide (positive electrode active material), and the molar ratio (F/Fe) of fluorine and iron was 0.

### Example 2-3

A lithium ion secondary battery according to Example 2-3 was fabricated in the same manner as in Example 1, except that the iron-containing solution and fluorine-containing aqueous solution were prepared such that the molar ratio of the iron ion contained in the iron-containing solution and the fluorine ion contained in the fluorine-containing aqueous solution was 1:1 (that is, the (fluorine ion/iron ion) molar ratio was 1). In this case, the molar ratio (F/Fe) of fluorine and iron contained in the coating film (Fe(II)-F—O) with the amorphous structure was 1.

### Example 2-4

A lithium ion secondary battery according to Example 2-4 was fabricated in the same manner as in Example 1, except that the iron-containing solution and fluorine-containing aqueous solution were prepared such that the molar ratio of the fluorine ion contained in the fluorine-containing aqueous solution and the iron ion contained in the iron-containing solution was 1:2 (that is, the (fluorine ion/iron ion) molar ratio was 2). In this case, the molar ratio (F/Fe) of fluorine and iron contained in the coating film (Fe(II)-F—O) with the amorphous structure was 2.

### Example 2-5

A lithium ion secondary battery according to Example 2-5 was fabricated in the same manner as in Example 1, except that the iron-containing solution and fluorine-containing aqueous solution were prepared such that the molar ratio of the fluorine ion contained in the fluorine-containing aqueous solution and the iron ion contained in the iron-containing solution was 1:3.5 (that is, the (fluorine ion/iron ion) molar ratio was 3.5). In this case, the molar ratio (F/Fe) of fluorine and iron contained in the coating film (Fe(II)-F—O) with the amorphous structure was 3.5.

### Example 2-6

A lithium ion secondary battery according to Example 2-6 was fabricated in the same manner as in Example 1, except that the iron-containing solution and fluorine-containing aqueous solution were prepared such that the molar ratio of the fluorine ion contained in the fluorine-containing aqueous solution and the iron ion contained in the iron-containing solution was 1:6 (that is, the (fluorine ion iron ion) molar ratio was 6). In this case, the molar ratio (F/Fe) of fluorine and iron contained in the coating film (Fe(II)-F—O) with the amorphous structure was 6.

[Charge and Discharge Cycle Test]

The fabricated lithium ion secondary batteries according to Examples 2-1 to 2-6 were subjected to the initial charge and discharge treatment. More specifically, the operation of charging at a constant current (CC) to 4.8 V at a charge rate of C/3 of the theoretical capacity of the positive electrode and the operation of discharging at a constant current to 2.5 V at a discharge rate of C/3 were repeatedly performed three times

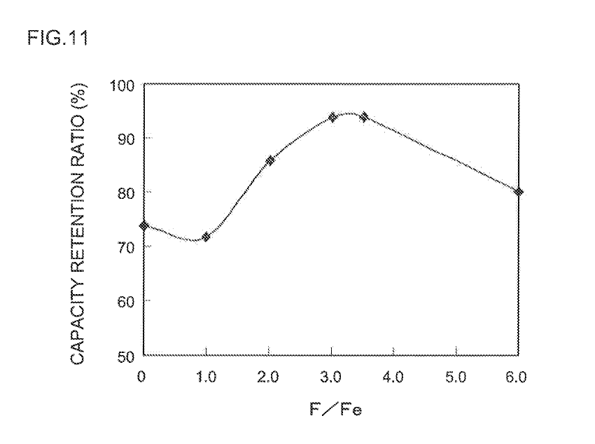

A total of 30 charge and discharge cycles were repeated and the capacity retention ratio (%) after 30 cycles was determined with respect to the lithium ion secondary batteries of Examples 2-1 to 2-6 after the initial charge and discharge treatment. Thus, charge and discharge conditions of 1 cycle for the lithium ion secondary batteries according to Examples 2-1 to 2-6 included constant-current and constant-voltage charging (CCCV charging) to a voltage of 4.6 V at a charge rate of 2 C and then constant-current discharging to a voltage of 2.5 V at a discharge rate of 2 C at a measurement temperature of 25° C. The discharge capacity of the first cycle and the discharge capacity of the thirtieth cycle were measured in each example. A ratio ((discharge capacity after 30 cycles)/(initial capacity)×100(%)) of the discharge capacity after 30 cycles to the discharge capacity after 1 cycle (initial capacity) was calculated as the capacity retention ratio (%). The measurement results are shown in FIG. 11 and Table 3.

TABLE 3

| | | | Capacity retention |
|---|---|---|---|
| Example | Coating film | Molar ratio (F/Fe) | ratio (%) |
| 2-1 | Fe(II)—F—O | 3 | 92 |
| 2-2 | Fe(II)—O | — | 74 |
| 2-3 | Fe(II)—F—O | 1 | 72 |
| 2-4 | Fe(II)—F—O | 2 | 86 |
| 2-5 | Fe(II)—F—O | 3.5 | 91 |
| 2-6 | Fe(II)—F—O | 6 | 80 |

As shown in FIG. 11 and Table 3, when the molar ratio (F/Fe) was greater than 1 and less than 6, the capacity retention ratio was high and excellent battery performance was demonstrated. The preferred molar ratio (F/Fe) is equal to or greater than 2 and equal to or less than 4. In particular where the molar ratio (F/Fe) was equal to or greater than 3 and equal to or less than 3.5, the capacity retention ratio was above 90% and excellent battery performance was demonstrated. Therefore, the test results have continued that excellent battery performance is demonstrated when the molar ratio (F/Fe) of fluorine and iron contained in the coating film with the amorphous structure is greater than 1 and less than 6 (preferably equal to or greater than 2 and equal to or less than 4, more preferably equal to or greater than 3 and equal to or less than 3.5).

It was also investigated how the capacity retention ratio of the lithium ion secondary battery changes depending on the type of the transition metal contained in the coating film with the amorphous structure including fluorine (F) that is formed on at least part of the surface of the manganese-containing lithium complex oxide.

### Fabrication of Lithium Ion Secondary Battery

### Example 2-7

A lithium ion secondary battery according to Example 2-7 was fabricated in the same manner as in Example 3.

### Example 2-8

The mixed material according to Example 2-8 was prepared by loading 0.089 g of manganese (II) acetate tetrahydrate as a manganese compound into N,N-dimethylformamide, dissolving by performing stirring and ultrasonic treatment, and then admixing 4 g of Li_{1.2}Mn_{0.54}Co_{0.13}Ni_{0.13}O₂ as a manganese-containing lithium complex oxide (positive electrode active material). A lithium ion secondary battery according to Example 2-9 was fabricated in the same manner as in Example 1, except that the mixed material according to Example 2-9 was used instead of the mixed material according to Example 1. The film-coated positive electrode active material according to Example 2-9 had a coating film (Mn(II)-F—O) with the amorphous structure including at least manganese and fluorine on the surface of the manganese-containing lithium complex oxide (positive electrode active material),

### Example 2-9

A lithium ion secondary battery according to Example 2-9 was fabricated in the same manner as in Example 5.

### Example 2-10

The mixed material according to Example 2-40 was prepared by loading 0.11 g of chromium (III) nitrate nonahydrate as a chromium compound into N,N-dimethylformamide, dissolving by performing stirring and ultrasonic treatment, and then admixing 4 g of Li_{1.2}Mn_{0.54}Co_{0.13}Ni_{0.13}O₂ as a manganese-containing lithium complex oxide (positive electrode active material). A lithium ion secondary battery according to Example 2-10 was fabricated in the same manner as in Example 1, except that the mixed material according to Example 2-10 was used instead of the mixed material according to Example 1. The film-coated positive electrode active material according to Example 2-10 had a coating film (Cr(III)-F—O) with the amorphous structure including at least chromium and fluorine on the surface of the manganese-containing lithium complex oxide (positive electrode active material).

### Example 2-11

The mixed material according to Example 2-11 was prepared by loading 0.089 g of nickel (II) acetate tetrahydrate as a nickel compound into N,N-dimethylformamide, dissolving by performing stirring and ultrasonic treatment, and then admixing 4 g of Li_{1.2}Mn_{0.54}Co_{0.13}Ni_{0.13}O₂ as a manganese-containing lithium complex oxide (positive electrode active material). A lithium ion secondary battery according to Example 2-11 was fabricated in the same manner as in Example 1, except that the mixed material according to Example 2-11 was used instead of the mixed material according to Example 1. The film-coated positive electrode active material according to Example 2-11 had a coating film (Ni(II)-F—O) with the amorphous structure including at least nickel and fluorine on the surface of the manganese-containing lithium complex oxide (positive electrode active material).

### Example 2-12

The mixed material according to Example 2-12 was prepared by loading 0.089 g of cobalt (II) acetate tetra hydrate as a cobalt compound into N,N-dimethylformamide, dissolving by performing stirring and ultrasonic treatment, and then admixing 4 g of Li_{1.2}Mn_{0.54}Co_{0.13}Ni_{0.13}O₂ as a manganese-containing lithium complex oxide (positive electrode active material). A lithium ion secondary battery according to Example 2-12 was fabricated in the same manner as in Example 1, except that the mixed material according to Example 2-12 was used instead of the mixed material according to Example 1. The film-coated positive electrode active material according to Example 2-12 had a coating film (Co(II)-F—O) with the amorphous structure including at least cobalt and fluorine on the surface of the manganese-containing lithium complex oxide (positive electrode active material),

[Charge and Discharge Cycle Test]

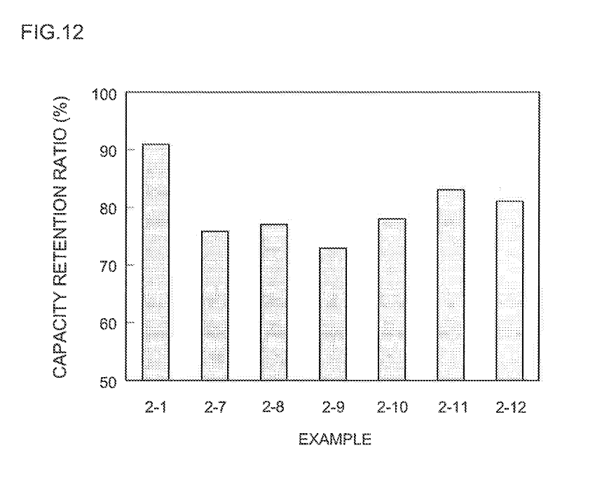

A test same as the charge and discharge cycle test performed with respect to the lithium ion secondary batteries of Examples 2-1 to 2-6 was also performed with respect to the fabricated lithium ion secondary batteries according to Examples 2-7 to 2-12. Thus, 30 cycles of charging and discharging were repeated with respect to the lithium ion secondary batteries according to Examples 2-7 to 2-12 and the capacity retention ratio C) after 30 cycles was determined. The measurement results are shown in FIG. 12 and Table 4. Table 4 also shows the measurement results obtained for the lithium ion secondary battery according to Example 2-1.

TABLE 4

| | | Capacity retention |
|---|---|---|
| Example | Coating film | ratio (%) |
| 2-1 | Fe(II)—F—O | 91 |
| 2-7 | None | 76 |
| 2-8 | Mn—F—O | 77 |
| 2-9 | Ti—F—O | 73 |
| 2-10 | Cr—F—O | 78 |
| 2-11 | Ni—F—O | 83 |
| 2-12 | Co—F—O | 81 |

As shown in FIG. 12 and Table 4, it was confirmed that the highest capacity retention ratio was obtained with the lithium ion secondary battery according to Example 2-1 using iron as a transition metal contained in the coating film with the amorphous structure including fluorine (F). The lithium ion secondary batteries according to Example 2-1 was confirmed to have a particularly excellent capacity retention ratio which was 8% higher than that of the lithium ion secondary battery according to Example 2-11 which had the second highest capacity retention ratio.

The specific examples of the present invention are explained hereinabove, but the above-described embodiments and examples are for the sake of description and place no limitation of the claims. Thus, the techniques set forth in the claims include various changes and modifications of the above-described specific examples.

### INDUSTRIAL APPLICABILITY

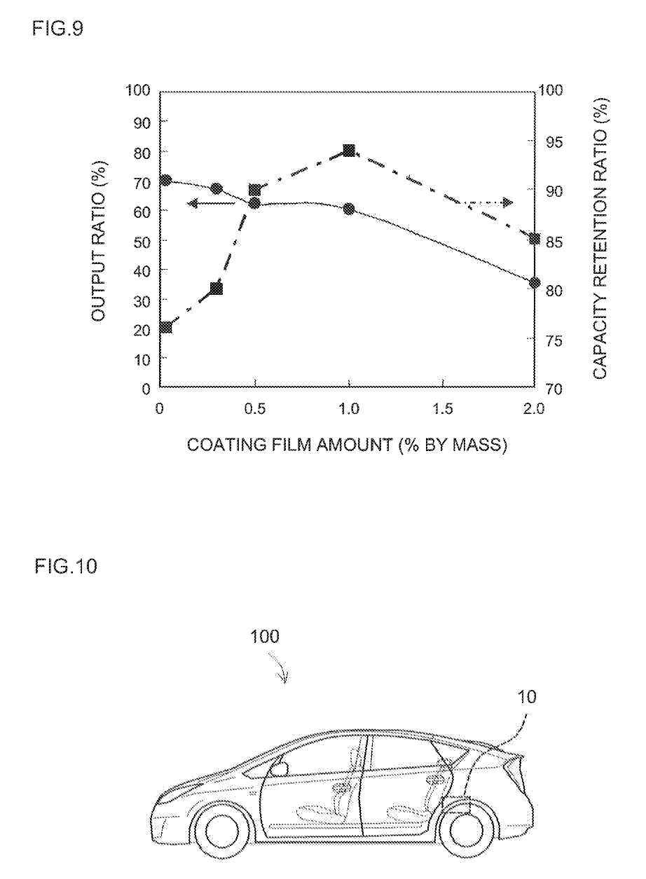

In the nonaqueous electrolyte secondary battery obtained by the manufacturing method in accordance with the present invention, the elution of manganese contained in the manganese-containing lithium complex oxide from the oxide into the nonaqueous electrolytic solution during charging and discharging is inhibited, and therefore the capacity retention ratio is prevented from decreasing. Such nonaqueous electrolyte secondary battery is suitable for a variety of applications. For example, it can be advantageously used as an electric power source (drive source) of a motor for driving a vehicle that is installed on a vehicle 100 such as an automobile, as shown in FIG. 10. The nonaqueous electrolyte secondary battery (lithium ion secondary battery) 10 used in the vehicle 100 may be used individually or in the form of a battery pack in which a plurality of batteries is connected in series and/or in parallel.

### REFERENCE SIGNS LIST

10 lithium ion secondary battery (nonaqueous electrolyte secondary battery)
15 battery case
20 opening
25 lid
30 case body
40 safety valve
50 electrode body (wound electrode body)
60 positive electrode terminal
62 positive electrode collector
64 positive electrode
66 positive electrode active material layer
70 filial-coated positive electrode active material (positive electrode active material)
72 manganese-containing lithium complex oxide
74 coating film
80 negative electrode terminal
82 negative electrode collector
84 negative electrode
86 negative electrode active material layer
90 separator
100 vehicle (automobile)

1. A lithium ion secondary battery comprising a positive electrode, a negative electrode, and a nonaqueous electrolytic solution, wherein
the positive electrode includes a positive electrode collector and a positive electrode active material layer including at least a positive electrode active material and formed on the positive electrode collector;
the positive electrode active material is a film-coated positive electrode active material that is mainly constituted by a manganese-containing lithium complex oxide including lithium and at least manganese as a transition metal element and includes a coating film of an amorphous structure including at least iron (Fe) and fluorine (F) formed on at least part of a surface of the manganese-containing lithium complex oxide.

2. The lithium ion secondary battery according to claim 1, wherein a molar ratio (F/Fe) of fluorine (F) to iron (Fe) included in the coating film with the amorphous structure is greater than 1 and less than 6.

3. The lithium ion secondary battery according to claim 1, wherein the amount of coating film is 0.5% by mass to 1.5% by mass, where the entire film-coated positive electrode active material is taken as 100% by mass.

4. The lithium ion secondary battery according to claim 1, wherein the manganese-containing lithium complex oxide includes a layered rock salt structure or a spinel structure.

5. The lithium ion secondary battery according to claim 4, wherein the manganese-containing lithium complex oxide includes a redox potential equal to or higher than 4.6 with respect to a metallic lithium electrode.

6. The lithium ion secondary battery according to claim 1, wherein the nonaqueous electrolytic solution includes at least an organic solvent and a lithium salt including fluorine (F) as a constituent element.

7. A method for manufacturing a lithium ion secondary battery including a positive electrode in which a positive electrode active material layer including at least a positive electrode active material is formed on a positive electrode collector, a negative electrode in which a negative electrode active material layer including at least a negative electrode active material is formed on a negative electrode collector, and a nonaqueous electrolytic solution,
the manufacturing method comprising:
forming an electrode body including the positive electrode and the negative electrode, and
accommodating in a battery case the electrode body together with the nonaqueous electrolytic solution, wherein
the positive electrode active material formed with a film-coated positive electrode active material obtained by following processing is used:
a step for preparing a mixed liquid obtained by mixing an iron-containing solution including at least one type of iron ion in an organic solvent, a fluorine-containing aqueous solution including at least one type of fluorine ion in water, and a manganese-containing lithium complex oxide including lithium and at least manganese as a transition metal element;
a step for producing a precursor by removing the organic solvent and water contained in the mixed liquid; and
a step for producing the film-coated positive electrode active material in which a coating film of an amorphous structure including at least iron (Fe) and fluorine (F) is formed on at least part of a surface of the manganese-containing lithium complex oxide by calcining the precursor.

8. The manufacturing method according to claim 7, wherein the iron-containing solution and the fluorine-containing aqueous solution are prepared such that a molar ratio (fluorine ion/iron ion) of fluorine ions contained in the fluorine-containing aqueous solution to iron ions contained in the iron-containing solution is greater than 1 and less than 6.

9. The manufacturing method according to claim 7, wherein the step for preparing the mixed liquid comprises:
preparing a mixed material in which the manganese-containing lithium complex oxide is mixed with an iron-containing solution in which an iron compound including at least one type of iron ion is dissolved in an organic solvent;
preparing a fluorine-containing aqueous solution in which a fluorine compound including at least one type of fluorine ion is dissolved in water; and
mixing the mixed material with the fluorine-containing aqueous solution.

10. The manufacturing method according to claim 7, wherein the mixed liquid is prepared such that the amount of the coating film is 0.5% by mass to 1.5% by mass, where the entire film-coated positive electrode active material is taken as 100% by mass.

11. The manufacturing method according to claim 7, wherein an oxide including a layered rock salt structure or a spinel structure is used as the manganese-containing lithium complex oxide.

12. The manufacturing method according to claim 11, wherein an oxide including a redox potential equal to or higher than 4.6 with respect to a metallic lithium electrode is used as the manganese-containing lithium complex oxide.

13. The manufacturing method according to claim 7, wherein a temperature at which the precursor is calcined is set to 400° C. to 550° C.

14. The manufacturing method according to claim 7, wherein the precursor is calcined in an inactive gas atmosphere.

15. The lithium ion secondary battery according to claim 1, wherein the lithium ion secondary battery is a drive source for a vehicle.
